(19) United States
(12) Patent Application Publication
(10) Pub. No.: US 2014/0363264 A1
(43) Pub. Date: Dec. 11, 2014

(54) GRIPPER ASSEMBLY FOR AUTONOMOUS MOBILE ROBOTS

(71) Applicant: HARVEST AUTOMATION, INC., BILLERICA, MA (US)

(72) Inventors: Jon Gowa, Medford, MA (US); Nathan Watts, Westminister, MA (US)

(73) Assignee: HARVEST AUTOMATION, INC., BILLERICA, MA (US)

(21) Appl. No.: 14/300,606

(22) Filed: Jun. 10, 2014

Related U.S. Application Data
(60) Provisional application No. 61/833,177, filed on Jun. 10, 2013.

(51) Int. Cl. B60P 1/50; B25J 15/00; B25J 5/00

(52) U.S. Cl. CPC B60P 1/50; B25J 5/007; B25J 15/0004; B25J 15/0028; Y10S 901/01; Y10S 901/39
USPC 414/539; 294/106; 901/1; 901/39

(57) ABSTRACT

A gripper assembly is provided for use in an autonomous mobile robot for grabbing and holding an object to be transported by the robot. The gripper assembly includes two rotatable shafts and two counter-rotating flippers, each fixedly connected to a different one of the rotatable shafts for engaging the object on opposite sides thereof. The gripper assembly also includes two drive elements, each engaging a different one of the rotatable shafts. Two drive arms engage the two drive elements to transfer torque and rotation from each drive arm to a respective drive element and rotatable shaft to open or close a respective flipper around the object. Each drive element can be disengaged from a respective drive arm and then rotated in order to adjust a radial position of a respective rotatable shaft and flipper relative to the drive arm so that objects of different sizes can be accommodated.

### CROSS REFERENCE TO RELATED APPLICATION

This application claims priority from U.S. Provisional Patent Application No. 61/833,177 filed on Jun. 10, 2013 entitled GRIPPER ASSEMBLY FOR AUTONOMOUS MOBILE ROBOTS, which is hereby incorporated by reference.

### BACKGROUND

The present application relates generally to autonomous mobile robots and, more particularly, to a gripper assembly for such robots usable for grabbing and securing objects to be transported by the robots.

### BRIEF SUMMARY OF THE DISCLOSURE

A gripper assembly is provided for use in an autonomous mobile robot for grabbing and holding an object to be transported by the robot. In accordance with one or more embodiments, the gripper assembly includes two rotatable shafts and two counter-rotating flippers, each fixedly connected to a different one of the rotatable shafts for engaging the object on opposite sides thereof. The gripper assembly also includes two drive elements, each engaging a different one of the rotatable shafts. Two drive arms engage the two drive elements to transfer torque and rotation from each drive arm to a respective drive element and rotatable shaft to open or close a respective flipper around the object. Each drive element can be disengaged from a respective drive arm and then rotated in order to adjust a radial position of a respective rotatable shaft and flipper relative to the drive arm so that objects of different sizes can be accommodated.

In accordance with one or more further embodiments, a method is provided for adjusting a gripper assembly in an autonomous mobile robot used for grabbing and holding an object to be transported by the robot. The gripper assembly includes two rotatable shafts and two counter-rotating flippers, each fixedly connected to a different one of the rotatable shafts for engaging the object on opposite sides thereof. The gripper assembly also includes two drive elements, each engaging a different one of the rotatable shafts. Two drive arms engage the two drive elements to transfer torque and rotation from each drive arm to a respective drive element and rotatable shaft to open or close a respective flipper around the object. The method includes the steps of: (a) disengaging a drive element from a respective drive arm, (b) rotating the drive element to adjust a radial position of a respective rotatable shaft and flipper relative to the drive arm in order to accommodate an object of a different size, and (c) re-engaging the drive element to the respective drive arm.

In accordance with one or more embodiments, an autonomous mobile robot is provided for transporting objects. The robot includes (a) a chassis, (b) a drive subsystem for maneuvering the chassis, (c) a gripper assembly on the chassis for grabbing and holding an object to be transported by the robot; (d) an object sensing subsystem on the chassis for detecting and locating objects; and (e) a controller on the chassis responsive to the object sensing subsystem and configured to control the drive subsystem and the gripper assembly in order to cause the robot to travel to a source location, pick up an object, transport the object to a destination location, and deposit the object at the destination location. The gripper assembly includes two rotatable shafts and two counter-rotating flippers, each fixedly connected to a different one of the rotatable shafts for engaging the object on opposite sides thereof. The gripper assembly also includes two drive elements, each engaging a different one of the rotatable shafts. Two drive arms engage the two drive elements to transfer torque and rotation from each drive arm to a respective drive element and rotatable shaft to open or close a respective flipper around the object. Each drive element can be disengaged from a respective drive arm and then rotated in order to adjust a radial position of a respective rotatable shaft and flipper relative to the drive arm so that objects of different sizes can be accommodated.

### BRIEF DESCRIPTION OF THE DRAWINGS

FIG. 1 is a perspective view of an exemplary autonomous mobile robot equipped with a gripper assembly in accordance with one or more embodiments.

FIG. 2 is a perspective view of the gripper assembly shown in FIG. 1.

FIG. 3 is a simplified block diagram illustrating select components of the robot of FIG. 1.

### DETAILED DESCRIPTION

Autonomous mobile robots are used in a variety of industries, including in the agricultural industry. For example, one particular use of autonomous robots is for performing automated potted plant processing operations. Specifically, robots can be used to identify, pick up, transport, and deposit container-holding plants as disclosed in co-pending U.S. patent application Ser. No. 12/378,612 filed on Feb. 18, 2009 and entitled ADAPTABLE CONTAINER HANDLING SYSTEM and U.S. patent application Ser. No. 13/100,763 filed on May 4, 2011 and entitled ADAPTABLE CONTAINER HANDLING ROBOT WITH BOUNDARY SENSING SUBSYSTEM.

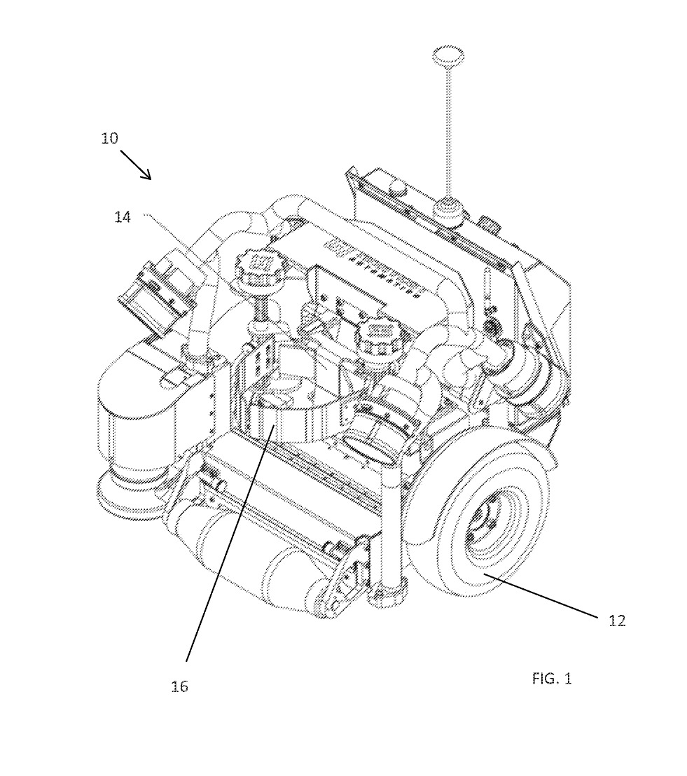

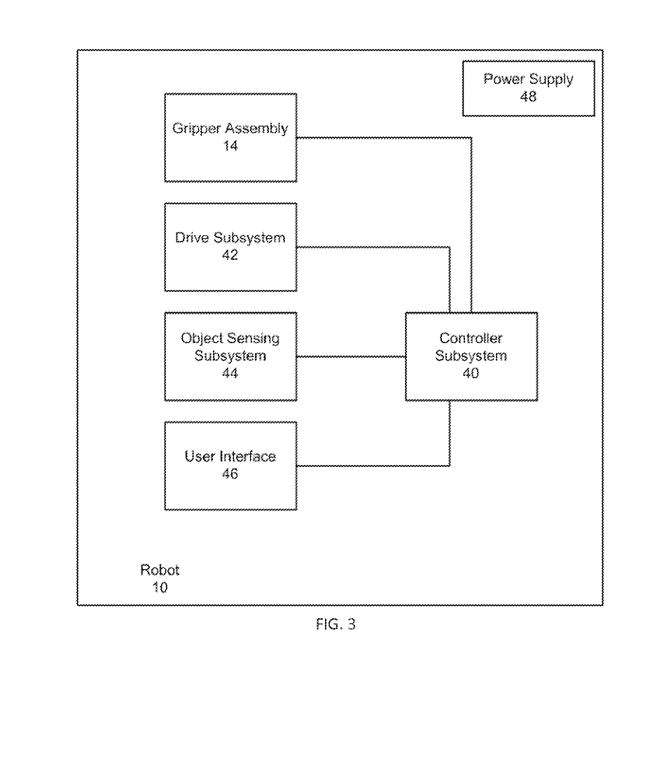

FIG. 1 illustrates an exemplary autonomous mobile robot 10 in accordance with one or more embodiments. The robot 10 is a diwheel-type robot having two wheels 12 on a common axle. The robot 10 also includes a gripper assembly 14, which allows the robot 10 to grab objects such as, e.g., plant containers, secure them during transport, and then place the containers in various spacing patterns. As shown in FIG. 3, the robot 10 also includes a microprocessor-based controller subsystem 40 for controlling overall operation of the robot 10. The controller subsystem 40 is configured or programmed to cause the robot 10 to perform various functions such as, e.g., picking up, transporting, and depositing potted plants.

The controller subsystem 40 controls the drive subsystem 42 of the robot 10 for maneuvering the robot 10. The drive subsystem 42 can comprise a differential drive including the two coaxial wheels 12. The wheels 12 can be driven together or independently by one or more motors and a drive train as controlled by the controller subsystem 40. The robot 10 also includes an object sensing subsystem 44 for detecting and locating objects like containers. The gripper assembly 14 is controlled by the controller subsystem 40 to pick up and deposit containers. A user interface (UI) 46 is provided to allow users to control operation of the robot 10. For instance, users can use the user interface to set container spacing parameters. A power supply 48 for all the subsystems can include one or more rechargeable batteries.

The gripper assembly 14 allows the robot 10 to grab objects such as round containers of various diameters, heights, and weights, secure them while they are being transported by the robot 10, and then place the containers in various spacing patterns. Spacing patterns can include, e.g., tight spacing where the containers are touching, known in some industries as ‘collection.’ The gripper assembly 14 comprises an end effector used to pick the containers off of the ground and transfer them into the robot chassis. The gripper assembly 14 is driven by a rotary actuator through a linkage mechanism. By way of example, the rotary actuator comprises a gearmotor or a pneumatic device.

In accordance with one or more embodiments, the gripper assembly 14 has several adjustable features to allow it to accommodate a wide range of container sizes. As described in further detail below, containers of varying diameters and heights can be retained by adjusting various user-operated controls.

The gripper assembly 14 functions by opening and closing two counter-rotating flippers or grippers 16 around a container. As the robot 10 approaches a container, a manipulator lowers the gripper assembly 14 and positions it in front of the robot 10. The flippers 16 are opened wide enough to allow the robot 10 to approach the container and envelope it between the flippers 16. The flippers 16 are then rotated inwards to grab the container securely against a backstop without crushing it. The gripper assembly 14 and container are then lifted back into the robot 10 for secure transport to another location. The linkage has an over-center geometry, which allows the gripper assembly 14 to maintain a secure hold of the container with the rotary actuator disengaged. The flippers 16 may be swapped out by the user to allow for handling of different shaped containers.

The gripper assembly 14 has a series of adjustment mechanisms, which allow it to adapt to containers of varying dimensions. The height of the flippers 16 can be adjusted to accommodate containers of various height ranges. The angle of the flippers 16 relative to each other can be adjusted to accommodate containers of various diameter or width. Additionally, the gripper assembly 14 utilizes a translating backstop feature (also referred to herein as the pusher bar), which can be adjusted to accommodate containers of varying diameters.

In addition to helping with the accommodation of various sized containers, the pusher bar also allows for very close spacing of containers, such that containers are touching each other after placement. The pusher bar allows the container to be placed in front of a group of previously spaced containers and then pushed into final position, nestled against the other containers. Without the pusher bar, tight spacing of containers might not be possible because the flippers 16 may otherwise interfere with previously placed containers if placement of the container between other tightly spaced containers was attempted.

The gripper assembly 14 enables round containers of varying height, diameter, taper, weight, and stiffness to be grasped using a single assembly 14 that is efficient, user-friendly, and cost effective. It allows the container to be lifted and transferred into a robot 10 so that it can be transported to a different location. The gripper assembly 14 also securely holds the container during transport in a passive manner, i.e., without power consumption. It performs these functions without damaging the container or its contents.

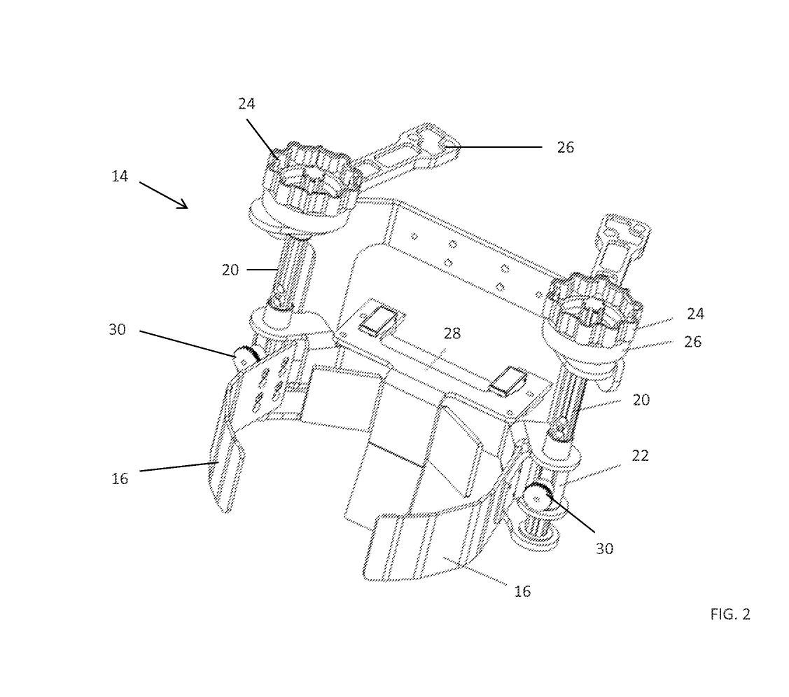

FIG. 2 is a more detailed view of an exemplary gripper assembly 14 in accordance with one or more embodiments. The gripper assembly 14 includes two splined shafts 20, each of which is used in its conventional manner to transmit torque from an actuator linkage to one of the flippers 16. The splined shaft 20 allows for axial adjustment of a flipper hub 22 with respect to the splined shaft 20, while maintaining radial alignment of the components. The splined shaft's custom circular outer diameter allows for standard bushings and retaining rings to be used, minimizing cost, complexity, and part count.

The gripper assembly 14 includes two gripper drive knobs or elements 24 that utilize a nested spline arrangement to allow the splined shafts 20 to be adjusted radially relative to two gripper drive arm 26. By pulling a gripper drive knob 24 away from the drive arm 26 axially (along the axis of a splined shaft 20), the male spline of the knob 24 is disengaged from the drive arm 26. Rotating the knob 24 and reseating it into the drive arm 26 in another position adjusts the radial positions of the flippers 16 to accommodate different diameter containers. The grippers 16 are spaced further away from each other to accommodate larger containers, and closer to each other to accommodate smaller containers.

The gripper assembly 14 also includes a pusher bar 28, which is adjustable to move forward (toward the tips of the flippers 16), or rearward. The adjustment allows the flippers 16 to better accommodate the geometry of containers of varying diameters.

The splined flipper hub 22 allows for axial movement of the flippers 16 with respect to the splined shaft 20 to accommodate containers of various heights. A retractable plunger 30 seats into holes along the length of each splined shaft 20, fixing the flippers 16 in an axial position.

The flippers 16 secure containers by closing inward toward each-other. Force is transmitted through the drive arms 26, the splined shafts 20, and the splined flipper hubs 22.

The gripper drive arms 26 transmit force through the actuator linkage to the splined shafts 20 by means of the gripper drive knobs 24.

The gripper assembly 14 in accordance with one or more embodiments functions as follows:
1. Power is supplied to a motor, which turns an output shaft a set number of degrees through a gearbox.
2. The output torque of the motor drives a linkage, which applies a force on the drive arms 26 causing them to rotate.
3. The drive arms 26 are coupled to the drive knobs 24 via a custom spline design, which transfers torque and rotation from the drive arms 26 to the drive knob 24. Each drive arm 26 has female spline features, and the drive knobs 24 have corresponding male spline features in the exemplary embodiment.
4. The drive knob 24 torque and rotation is transmitted to the drive shaft 20 via another custom spline arrangement. The drive knob 24 has female spline features, and the drive shaft 20 has male spline features in the exemplary embodiment. The custom spline employs a round outer diameter for the male drive shaft 20, which allows for the use of commercially available drive train components such as bearings, bushings, shaft retaining hardware, etc.
5. Torque and rotation are transmitted from the drive shaft 20 to the flipper hub 22 through the same spline profile as that between the drive knob 24 and drive shaft 20. The flipper hub 22 has the same female spline features as the drive knob 24.
6. The flippers 16 are rigidly coupled to the flipper hubs 22 with threaded fasteners. Threaded fasteners allow the flippers 16 to be replaced when worn out or allow them to be swapped for different flipper shapes to accommodate a range of container geometries without impacting the rest of the assembly 14.
7. The flippers 16 counter-rotate and pull the container in against the pusher bar 28.
8. The pusher bar 28 can be adjusted in and out to reduce or increase the area between it and the flippers 16 to best match the desired container diameter.
9. The flipper hubs 22 can slide vertically along the drive shaft 20 to adjust the flipper 18 and pusher bar 28 height relative to the rest of the gripper assembly 14.
10. The vertical height of the flippers 16 is set by engaging a series of holes in the drive shafts 20 with pins extending from spring-loaded plungers 30 attached to the flipper hubs 22. Retracting the pins by compressing the springs allows the flipper hubs 22 to be translated freely in the axial direction along the drive shaft 20. Releasing the pins causes them to extend into the holes in the drive shaft 20, preventing axial translation of the flipper hubs 22.
11. The angle of the flippers 16 can be adjusted relative to each other and to the rest of the gripper assembly 14 by rotating the drive knob 24 relative to the drive arm 26. This adjustment allows the gripper assembly 14 to accommodate a wide range of container diameters, while maintaining consistent linkage geometry and gearmotor or other rotary actuator operation. The drive knob 24 is held down into the drive arm 26 by a compression spring. Pulling up on the drive knob 24 against the spring disengages the spline and allows the drive knob 24, drive shaft 20, and flipper 18 to be rotated freely relative to the drive arm 26. When the drive knob 24 is released, the compressed spring causes it to re-engage with the drive arm 26 in the newly set position.

The adjustable gripper pusher bar 28 allows pots of varying diameters to be better retained with flippers 16 that do not require variable geometry. The pusher bar 28 also allows for very close spacing of containers, such that containers are touching each other after placement.

The gripper assembly 14 uses swappable components, such as the flippers 16, which allow for adaptation of the gripper to a wide variety of container shapes and sizes.

Additionally, features on the gripper like the round spline allow the shaft to be fully splined, and thus comprising an extrudable element, while still allowing features such as retaining ring grooves or bushings to be placed at any point along its length.

The gripper assembly 14 disclosed in the illustrative embodiments above is provided by way of example only. Various modifications are possible. For example, the flippers described and shown in the drawings are geometrically optimized to secure certain types of containers. Flippers of different geometries or materials could be substituted. Additionally, several parts could be eliminated without changing the function of the assembly 14, such as the cosmetic parts that cover the gripper knobs, or the springs that better retain the knobs to the assembly 14.

In the exemplary embodiments described above the gripper assembly 14 is used for transferring containers for plants. The assembly 14 can also be used to secure and manipulate other objects including, e.g., circular (and other-shaped) containers other than those used for potted plants of varying diameters or widths and heights. For example, large 5 gallon containers of water, as well as small 1 liter water containers, could be secured and manipulated using the gripper assembly 14.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Additionally, elements and components described herein may be further divided into additional components or joined together to form fewer components for performing the same functions. Accordingly, the foregoing description and attached drawings are by way of example only, and are not intended to be limiting.

What is claimed is:

1. A gripper assembly in an autonomous mobile robot for grabbing and holding an object to be transported by the robot, the gripper assembly comprising:
two rotatable shafts;
two counter-rotating flippers, each fixedly connected to a different one of the rotatable shafts for engaging the object on opposite sides thereof;
two drive elements, each engaging a different one of the rotatable shafts; and
two drive arms, each engaging a different one of the drive elements to transfer torque and rotation from the drive arm to a respective drive element and rotatable shaft to open or close a respective flipper around the object,
wherein each drive element is disengageable from a respective drive arm and rotatable when disengaged from the drive arm to adjust a radial position of a respective rotatable shaft and flipper relative to the drive arm in order to accommodate objects of different sizes.

2. The gripper assembly of claim 1, further comprising a pusher bar forming a backstop for the object held by the flippers.

3. The gripper assembly of claim 2, wherein the pusher bar can be actuated to push the object to a destination position when the flippers are in an opened position.

4. The gripper assembly of claim 1, wherein the gripper assembly holds the object during transport by the robot without power consumption.

5. The gripper assembly of claim 1, wherein each of the rotatable shafts comprises a splined shaft, and wherein each of the drive elements has female spline features to engage corresponding male spline features of the rotatable shafts.

6. The gripper assembly of claim 1, wherein the drive arms engage the drive elements using splined features.

7. The gripper assembly of claim 6, wherein each of the drive arms includes female spline features and each of the drive elements includes corresponding male spline features.

8. The gripper assembly of claim 1, wherein the flippers are connected to the rotatable shafts through flipper hubs.

9. The gripper assembly of claim 8, wherein the flippers are removably connected to the flipper hubs.

10. The gripper assembly of claim 8, wherein the flipper hubs are axially movable along the rotatable shafts to adjust the axial position of the flippers to accommodate objects of different heights.

11. The gripper assembly of claim 10, the axial position of each flipper can be set by engaging a selected hole in the rotatable shaft with a pin extending from a spring-loaded plunger in the flipper hub.

12. The gripper assembly of claim 1, wherein the drive elements comprise knobs, which are biased toward engagement with respective drive arms by a compression spring.

13. The gripper assembly of claim 1, wherein the object comprises a round plant container.

14. A method of adjusting a gripper assembly in an autonomous mobile robot, the gripper assembly for grabbing and holding an object to be transported by the robot, the gripper assembly comprising two rotatable shafts; two counter-rotating flippers, each fixedly connected to a different one of the rotatable shafts for engaging the object on opposite sides thereof; two drive elements, each engaging a different one of the rotatable shafts; and two drive arms, each engaging a different one of the drive elements to transfer torque and rotation from the drive arm to a respective drive element and rotatable shaft to open or close a respective flipper around the object, the method comprising the steps of:
disengaging a drive element from a respective drive arm;
rotating the drive element to adjust a radial position of a respective rotatable shaft and flipper relative to the drive arm in order to accommodate an object of a different size; and
re-engaging the drive element to the respective drive arm.

15. The method of claim 14, wherein the flippers are connected to the rotatable shafts through flipper hubs, the method further comprising adjusting an axial position of the flippers to accommodate objects of different heights by:
moving each flipper hub from a first axial position to a second axial position on a respective rotatable shaft; and
setting the flipper hub in place at the second axial position on the rotatable shaft.

16. The method of claim 15, wherein setting the flipper hub comprises engaging a selected hole in the rotatable shaft with a pin extending from a spring-loaded plunger in the flipper hub.

17. An autonomous mobile robot for transporting objects, comprising:
(a) a chassis;
(b) a drive subsystem for maneuvering the chassis;
(c) a gripper assembly on the chassis for grabbing and holding an object to be transported by the robot;
(d) an object sensing subsystem on the chassis for detecting and locating objects; and
(e) a controller on the chassis responsive to the object sensing subsystem and configured to control the drive subsystem and the gripper assembly in order to cause the robot to travel to a source location, pick up an object, transport the object to a destination location, and deposit the object at the destination location,
wherein the gripper assembly comprises:
two rotatable shafts;
two counter-rotating flippers, each fixedly connected to a different one of the rotatable shafts for engaging the object on opposite sides thereof;
two drive elements, each engaging a different one of the rotatable shafts; and
two drive arms, each engaging a different one of the drive elements to transfer torque and rotation from the drive arm to a respective drive element and rotatable shaft to open or close a respective flipper around the object,
wherein each drive element is disengageable from a respective drive arm and rotatable when disengaged from the drive arm to adjust a radial position of a respective rotatable shaft and flipper relative to the drive arm in order to accommodate objects of different sizes.

18. The autonomous mobile robot of claim 17, wherein the gripper assembly further comprises a pusher bar forming a backstop for the object held by the flippers.

19. The autonomous mobile robot of claim 18, wherein the pusher bar can be actuated to push the object to a destination position when the flippers are in an opened position.

20. The autonomous mobile robot of claim 17, wherein the gripper assembly holds the object during transport by the robot without power consumption.

21. The autonomous mobile robot of claim 17, wherein each of the rotatable shafts in the gripper assembly comprises a splined shaft, and wherein each of the drive elements has female spline features to engage corresponding male spline features of the rotatable shafts.

22. The autonomous mobile robot of claim 17, wherein the drive arms engage the drive elements using splined features.

23. The autonomous mobile robot of claim 22, wherein each of the drive arms includes female spline features and each of the drive elements includes corresponding male spline features.

24. The autonomous mobile robot of claim 17, wherein the flippers are connected to the rotatable shafts through flipper hubs.

25. The autonomous mobile robot of claim 24, wherein the flippers are removably connected to the flipper hubs.

26. The autonomous mobile robot of claim 24, wherein the flipper hubs are axially movable along the rotatable shafts to adjust the axial position of the flippers to accommodate objects of different heights.

27. The autonomous mobile robot of claim 26, the axial position of each flipper can be set by engaging a selected hole in the rotatable shaft with a pin extending from a spring-loaded plunger in the flipper hub.

28. The autonomous mobile robot of claim 17, wherein the drive elements comprise knobs, which are biased toward engagement with respective drive arms by a compression spring.

29. The autonomous mobile robot of claim 17, wherein the object comprises a round plant container.
